(19) United States
(12) Patent Application Publication
(10) Pub. No.: US 2026/0192868 A1
(43) Pub. Date: Jul. 9, 2026

(54) BOTTOM STRUCTURE OF VEHICLE

(71) Applicant: Honda Motor Co., Ltd., Tokyo (JP)

(72) Inventors: Hidefumi NIHEI, Tokyo (JP); Yuhei NOMI, Tokyo (JP); Keita SASAKI, Tokyo (JP); Junichi SHIO, Tokyo (JP)

(73) Assignee: Honda Motor Co., Ltd., Tokyo (JP)

(21) Appl. No.: 19/435,659

(22) Filed: Dec. 29, 2025

(30) Foreign Application Priority Data
Jan. 3, 2025 (CN) 202510011266.4

(51) Int. Cl. B62D 35/02

(52) U.S. Cl. CPC B62D 35/02

(57) ABSTRACT

A bottom structure of vehicle includes a vehicle body, with tires disposed on left and right sides thereof, and a chassis, covering a lower surface between left and right tires, and including a bottom plate surface, covering the lower surface, and an installation base, recessing from a bottom plate surface toward inner side of cabin. The installation base is disposed closer to the tire than center of vehicle body, is disposed closer to back of vehicle than a front part of tire, and includes an installation surface installing the chassis to the vehicle body, a front inclined surface, connected to the bottom plate surface and front of installation surface, and a back inclined surface, connected to back of installation surface and the bottom plate surface, having gentler tilt than the front inclined surface, and extending from installation surface toward back of vehicle and toward inner side in vehicle width direction.

### CROSS-REFERENCE TO RELATED APPLICATION

This application claims the priority benefit of China application serial no. 202510011266.4, filed on January 3, 2025. The entirety of the above-mentioned patent application is hereby incorporated by reference herein and made a part of this specification.

### BACKGROUND

### Technical Field

The disclosure relates to a bottom structure of vehicle, and in particular to a bottom structure of vehicle capable of improving aerodynamic performance.

### Related Art

Recently, in order to ensure access to more affordable, reliable, sustainable, and advanced energy for more people, research for improving fuel efficiency that contributes to energy efficiency has been conducting.

In Patent Document 1 (Japanese Patent No. 4594220), in a bottom plate portion of a front chassis, an extended inclined portion is formed on a recessed portion of back of side of a vehicle to extend a length of an opening portion in a front-back direction. A front portion to a back portion of the extended inclined portion tilts from a front upper side toward a lower side of the vehicle. By disposing the extended inclined portion, turbulent flow generated by air flow from the front side of the vehicle entering the recessed portion may be suppressed, thereby suppressing increase of air resistance. However, direction of the airflow on the lower surface of vehicle body differs depending on the portions. Therefore, if the inclined surface is formed to extend only along the front-back direction of the vehicle body as in Patent Document 1, the increase of air resistance may not be sufficiently suppressed.

### SUMMARY

In order to solve the technical problems, the disclosure provides a bottom structure of vehicle that may sufficiently suppress increase of air resistance, thereby improving aerodynamic performance and contributing to energy efficiency.

In order to achieve the objective, according to the technical solutions of an embodiment, the disclosure provides a bottom structure of vehicle disposed in a vehicle. The vehicle has tires. The bottom structure of vehicle includes a vehicle body, with a tire disposed on left and right sides of the vehicle body, and a chassis, covering the lower surface of the vehicle body between the left and right tires from lower of the vehicle. The chassis includes a bottom plate surface, covering the lower surface of the vehicle body, and an installation base, recessing from the bottom plate surface toward an inner side of a cabin of the vehicle. The installation base is disposed at a position closer to the tire than a center of the vehicle body. The installation base is disposed at a position closer to back of the vehicle than a front of the tire. The installation base includes an installation surface, configured to install the chassis to the vehicle body, a front inclined surface, connected to the bottom plate surface and a front part of the installation surface, and a back inclined surface, connected to a back part of the installation surface and the bottom plate surface. The back inclined surface is configured to have a gentler tilt than the front inclined surface, and extends from the installation surface toward back of the vehicle and toward an inner side of the vehicle in a vehicle width direction.

Since the back inclined surface of the installation base tilts more gently than the front inclined surface, a turbulent flow caused by air flowing at lower of the installation base to enter the installation base may be suppressed, thereby an increase of air resistance may be suppressed. The air flowing on the lower surface of the side of the vehicle body impacts the front part of the tire to slow down flow velocity, and therefore, at back of the front part of the tire, the flow velocity of the air flowing toward the center of the vehicle body becomes faster. By disposing the installation base at the position closer to back of the vehicle than the front part of the tire and located on an inner side in the vehicle width direction, and by making the back inclined surface of the installation base extend toward back of the vehicle and toward an inner side of the vehicle in the vehicle width direction, the increase of air resistance may be suppressed more effectively.

In the embodiments of the bottom structure of vehicle of the disclosure, the air at down of the chassis flows rapidly in the center of the flat vehicle body. The air of the side of the chassis is disturbed by the tire, the strip plate, and the suspension component to slow down the velocity, and is guided to the center of the vehicle body with a faster flow the velocity. According to the position where the installation base is disposed, the installation base is disposed by tilting toward the center of the vehicle body. In this way, aerodynamic performance of the bottom structure of vehicle may be improved more effectively, and air resistance may be effectively suppressed, which contributes to efficiency of energy.

In order to make the above-mentioned features and advantages of the disclosure comprehensible, embodiments accompanied with drawings are described in detail below.

### BRIEF DESCRIPTION OF THE DRAWINGS

FIG. 1 is a schematic view of a vehicle according to an embodiment of the disclosure.

FIG. 2 is a schematic view of a bottom structure of vehicle according to an embodiment of the disclosure.

FIG. 3 is a schematic view of a chassis of a bottom structure of vehicle according to an embodiment of the disclosure.

FIG. 4 is an enlarged schematic view of an area A of the bottom structure of vehicle of FIG. 2.

FIG. 5 is a cross-sectional schematic view along a line C-C of FIG. 4.

FIG. 6 is a schematic view of an uncovered area of a bottom structure of vehicle according to an embodiment of the disclosure.

FIG. 7 is a schematic view of a first installation base and a second installation base of a bottom structure of vehicle according to an embodiment of the disclosure.

FIG. 8 is a schematic view of a frame component and a suspension component of a bottom structure of vehicle according to an embodiment of the disclosure.

FIG. 9 is a schematic view of a strip plate of a bottom structure of vehicle according to an embodiment of the disclosure.

FIG. 10 is a schematic view of air flow of a bottom structure of vehicle according to an embodiment of the disclosure.

### DESCRIPTION OF THE EMBODIMENTS

The disclosure provides a bottom structure of vehicle disposed in a vehicle. The vehicle has tires. The bottom structure of vehicle includes a vehicle body, with a tire disposed on left and right sides of the vehicle body, and a chassis, covering the lower surface of the vehicle body between the left and right tires from lower of the vehicle. The chassis includes a bottom plate surface, covering the lower surface of the vehicle body, and an installation base, recessing from the bottom plate surface toward an inner side of a cabin of the vehicle. The installation base is disposed at a position closer to the tire than a center of the vehicle body, and is disposed at a position closer to back of the vehicle than a front part of the tire. The installation base includes an installation surface, configured to install the chassis to the vehicle body, a front inclined surface, connected to the bottom plate surface and a front part of the installation surface, and a back inclined surface, connected to a back part of the installation surface and the bottom plate surface. The back inclined surface is configured to have a gentler tilt than the front inclined surface, and extends from the installation surface toward back of the vehicle and toward an inner side in a vehicle width direction of the vehicle.

Since the back inclined surface of the installation base tilts more gently than the front inclined surface, a turbulent flow caused by air flowing at lower of the installation base to enter the installation base may be suppressed, thereby an increase of air resistance may be suppressed.

The air flowing on the lower surface of the side of the vehicle body impacts the front part of the tire to slow down flow velocity, and therefore, at back of the front part of the tire, the flow velocity of the air flowing toward the center of the vehicle body becomes faster. By disposing the installation base at the position closer to back of the vehicle than the front part of the tire and located at an inner side in the vehicle width direction, and by making the back inclined surface of the installation base extend toward back of the vehicle and toward an inner side in the vehicle width direction of the vehicle, the increase of air resistance may be suppressed more effectively.

In an embodiment of the disclosure, an uncovered area that is not covered by the chassis is formed on an inner side of the tire in the vehicle width direction. At least one installation base is disposed on an inner side of the uncovered area in the vehicle width direction.

The air flow in the uncovered area that is not covered by the chassis is easily disturbed, making the flow velocity of air in the uncovered area slower than flow velocity of air in the center of the vehicle body where the chassis is located. As the flow velocity of the air becomes slower, the air flows toward a direction of the center of the vehicle body where the flow velocity is faster. Therefore, by disposing the installation base on an inner side of the uncovered area in the vehicle width direction, and by making the back inclined surface of the installation base extend toward back of the vehicle and toward an inner side of the vehicle in the vehicle width direction, the increase of air resistance may be effectively suppressed.

In an embodiment of the disclosure, the bottom structure of vehicle further includes a suspension component disposed in the uncovered area.

Even at a portion where the air flow is easily disturbed by the suspension component, by making the back inclined surface of the installation base extend toward back of the vehicle and toward an inner side of the vehicle in the vehicle width direction, the increase of air resistance may be effectively suppressed.

In an embodiment of the disclosure, the installation base includes a first installation base disposed at a position closer to back of the vehicle than the front of tire and disposed at a position on an inner side of the vehicle body, a second installation base disposed at a position closer to back of the vehicle than the first installation base and disposed on an inner side of the uncovered area in the vehicle width direction. Relative to the back inclined surface of the first installation base, the back inclined surface of the second installation base extends by tilting toward an inner side in the vehicle width direction.

The air flowing lower of the vehicle body impacts the front part of the tire, deflects toward the inner side of the vehicle body, and flows toward back of the inner side of the vehicle body. The air flowing toward back of the inner side of the vehicle body is decelerated by the uncovered area formed on an inner side of the tire, further deflects toward the inner side of the vehicle body, and flows toward back of the inner side of the vehicle body. Accordingly, by making the back inclined surface of the second installation base tilt toward the inner side to a greater extent than the back inclined surface of the first installation base, a shape of the installation base following the air flow may be formed, and the increase of air resistance may be suppressed more effectively.

In an embodiment of the disclosure, the vehicle body includes a frame component. The frame component extends from a front part of the tire toward back of the vehicle and toward the inner side in the vehicle width direction. The installation base is disposed along the frame component.

Since the frame component extends from the front part of the tire toward back of the vehicle and toward the inner side in the vehicle width direction, the installation base may be easily disposed along a path of the air flow on the lower surface of the vehicle body.

In an embodiment of the disclosure, the bottom structure of vehicle further includes a suspension component disposed on the inner side of the tire in the vehicle width direction. The frame component is disposed on the inner side in the vehicle width direction relative to the suspension component.

Since the frame component is disposed on the inner side in the vehicle width direction relative to the suspension component, the installation base may be easily disposed along the path of the air flow on the lower surface of the vehicle body.

In an embodiment of the disclosure, the bottom structure of vehicle further includes a strip plate disposed in front of the tire. The strip plate extends from the vehicle body toward lower of the vehicle. A bottom end of the strip plate is located at lower of the chassis.

Even when the flow velocity of the air on the side of the vehicle body becomes slower than the flow velocity of the air in the center of the vehicle body due to the strip plate, the increase of air resistance may be effectively suppressed.

Hereinafter, exemplary embodiments of the disclosure will be explained based on the drawings. It should be noted that in each embodiment described below, the same reference numerals are assigned to common parts, and redundant descriptions are omitted. In the following, embodiments of the disclosure will be described with reference to the drawings.

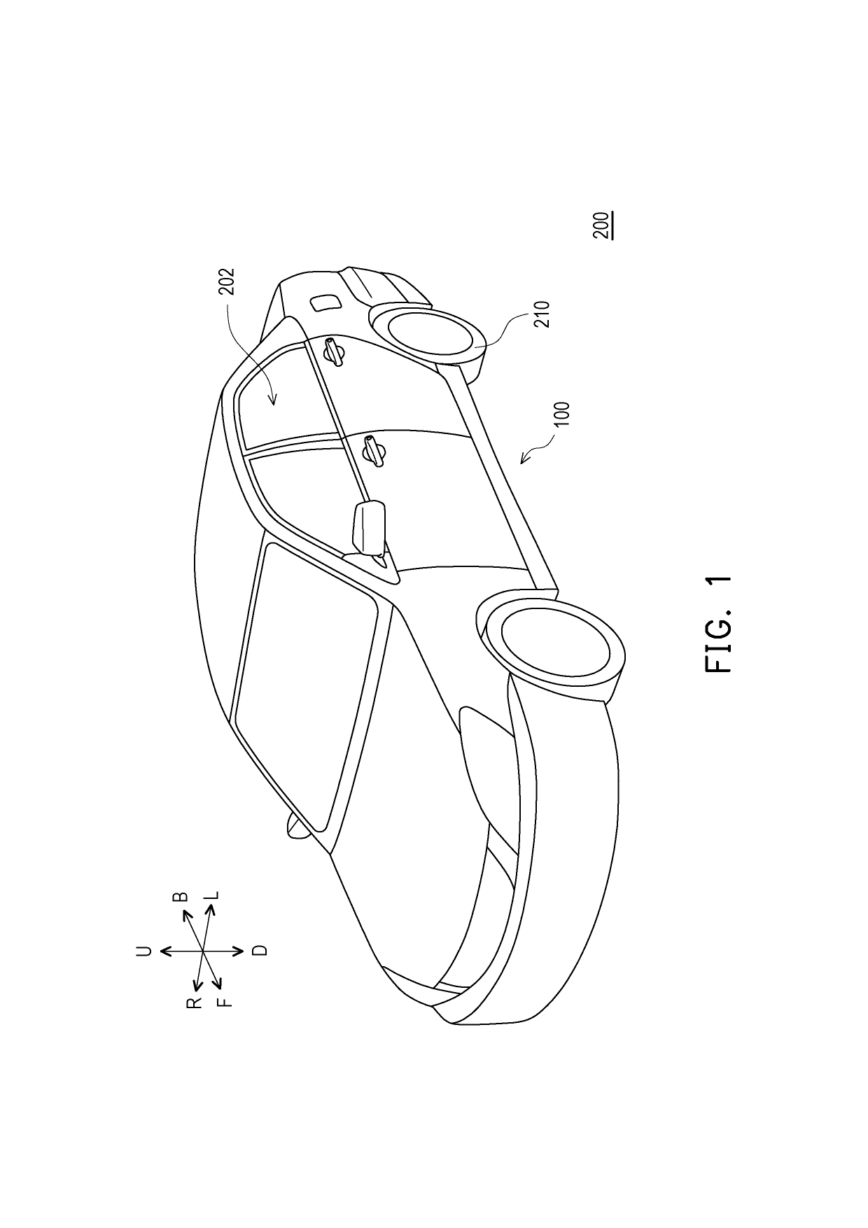

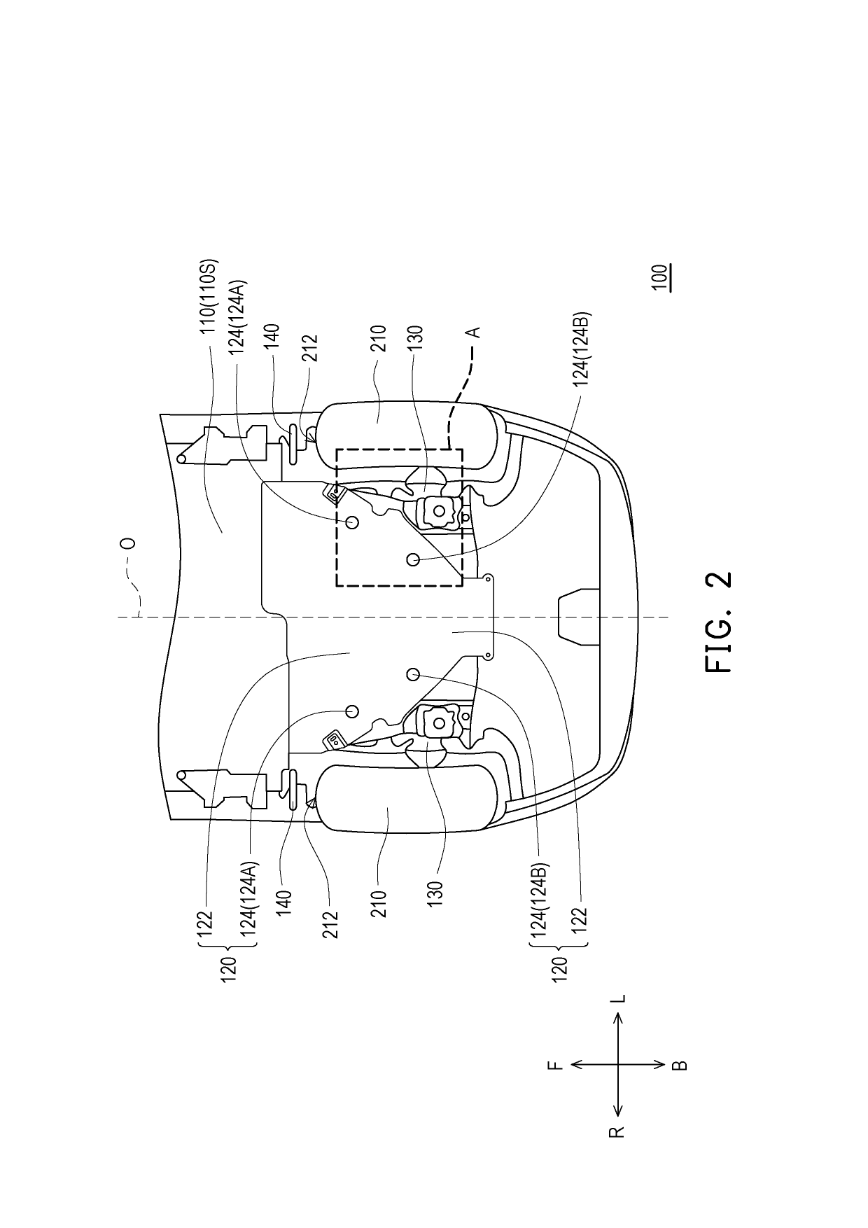

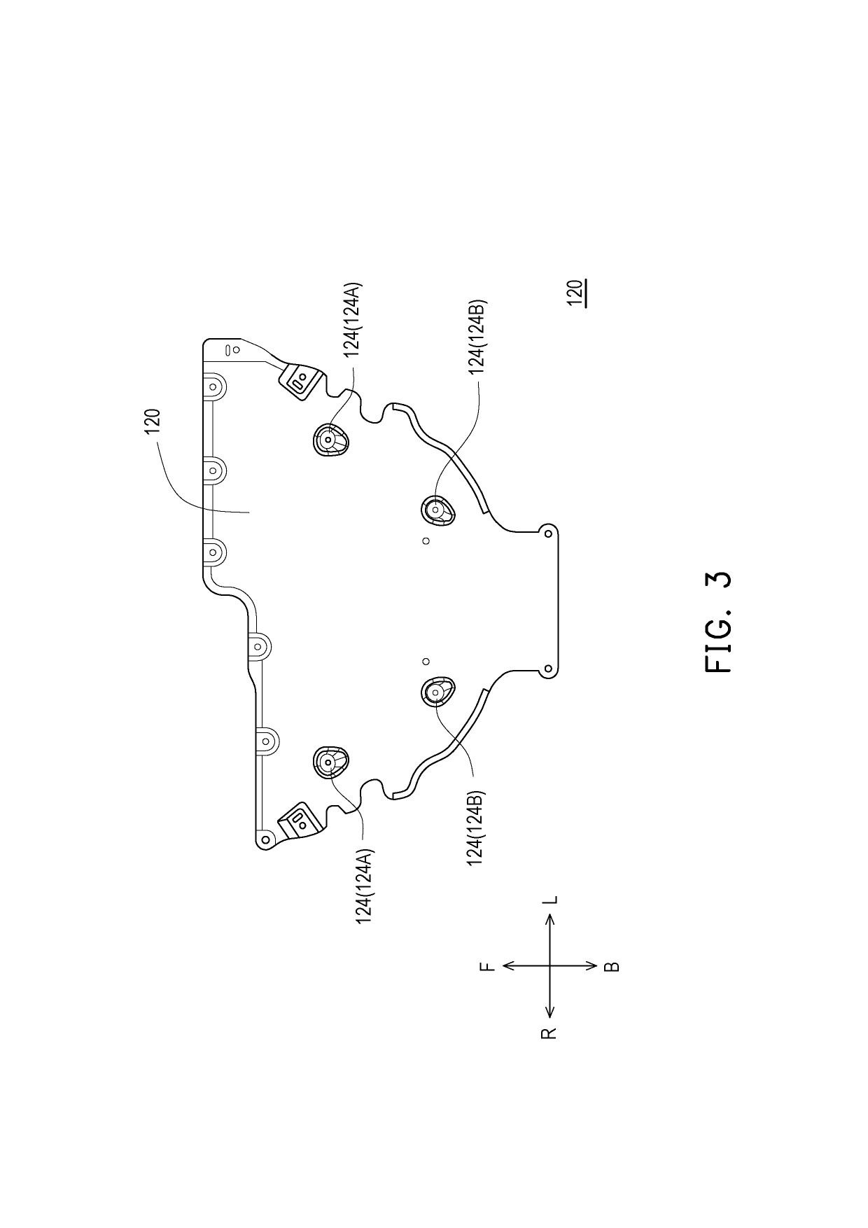

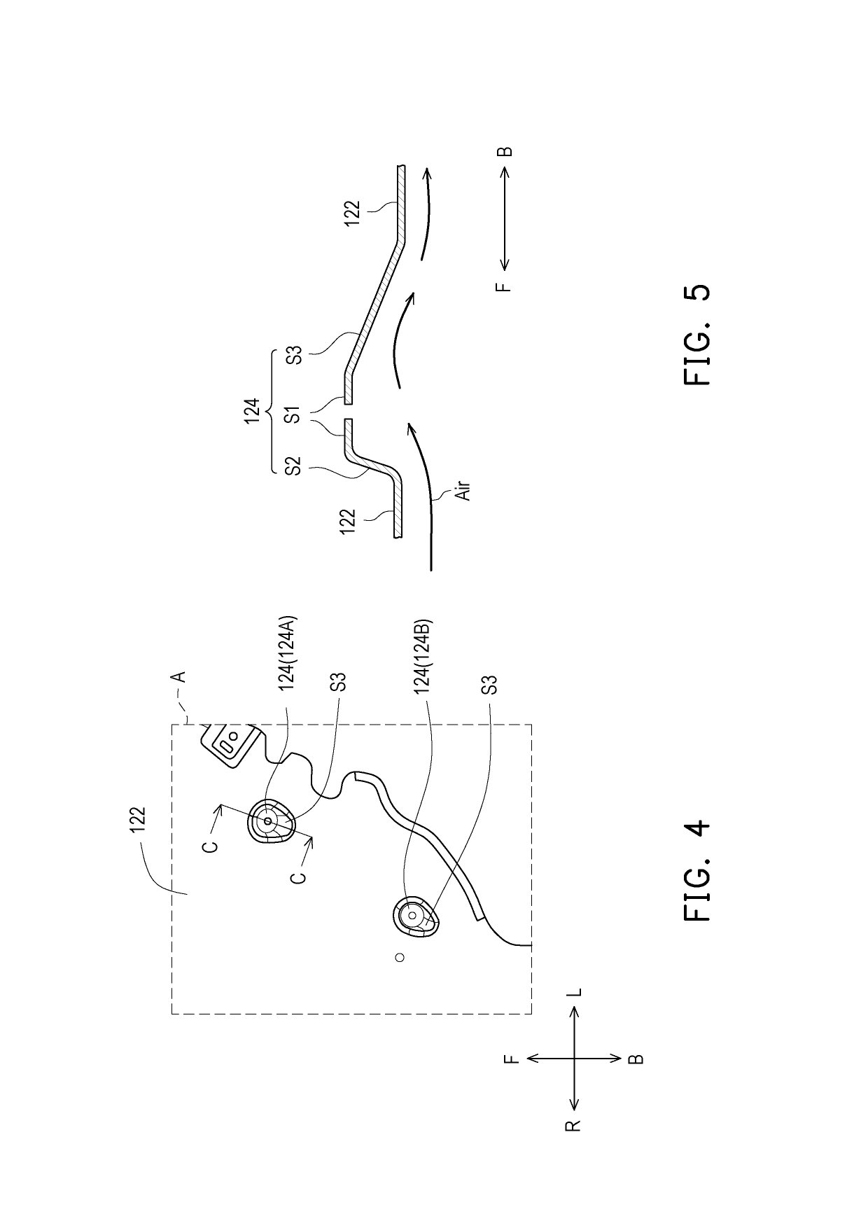

FIG. 1 is a schematic view of a vehicle according to an embodiment of the disclosure. FIG. 2 is a schematic view of a bottom structure of vehicle according to an embodiment of the disclosure. FIG. 3 is a schematic view of a chassis of a bottom structure of vehicle according to an embodiment of the disclosure. FIG. 4 is an enlarged schematic view of an area A of the bottom structure of vehicle of FIG. 2. FIG. 5 is a cross-sectional schematic view along a line C-C of FIG. 4.

With reference to FIG. 1, FIG. 1 shows upper U, down D, front F, back B, left L, and right R of a vehicle 200. The vehicle 200 has a cabin 202 and tires 210. A bottom structure 100 of the vehicle 200 is disposed at down D of the vehicle 200.

With reference to FIG. 1 to FIG. 2, the bottom structure 100of the vehicle 200 is disposed in the vehicle 200. The vehicle 200 has the tires 210. The bottom structure 100 of the vehicle 200 includes a vehicle body 110, tires 210 disposed on left and right sides of vehicle body 110, and a chassis 120 covering a lower surface 110S of the vehicle body 110 between the tires 210 on left and right sides from down D of the vehicle 200.

With reference to FIG. 2 to FIG. 3, the chassis 120 includes a bottom plate surface 122 covering the lower surface 110S of the vehicle body 110 and an installation base 124 recessing from the bottom plate surface 122 toward an inner side of the cabin 202 of the vehicle 200. The installation base 124 is disposed at a position closer to the tire 210 than a center O of the vehicle body 110, and the installation base 124 is disposed at a position closer to back B of the vehicle 200 than a front part 212 of the tire 210.

With reference to FIG. 2 and FIG. 4 to FIG. 5, the installation base 124 includes an installation surface S1 configured to install the chassis 120 to the vehicle body 110, a front inclined surface S2 connected to the bottom plate surface 122 and a front part of the installation surface S1, and a back inclined surface S3 connected to a back part of the installation surface S1 and the bottom plate surface 122. As shown in FIG. 4 and FIG. 5, the back inclined surface S3 is configured to have a gentler tilt than the front inclined surface S2 and extend from the installation surface S1 toward the back B of the vehicle 200 and toward an inner side of the vehicle 200 in a vehicle width direction L-R.

Since the back inclined surface S3 of the installation base 124 tilts more gently than the front inclined surface S2, a turbulent flow caused by air (with reference to FIG. 5) flowing at down of the installation base 124 to enter the installation base 124 may be suppressed, thereby an increase of air resistance may be suppressed. The air flowing on the lower surface of the side of the vehicle body 110 may impact the front part 212 of the tire 210 to slow down flow velocity, and therefore, at back of the front part 212 of the tire 210, the flow velocity of the air flowing toward the center O of the vehicle body 110 may become faster. By disposing the installation base 124 at the position closer to the back B of the vehicle 200 than the front part 212 of the tire 210 and located on the inner side in the vehicle width direction L-R, and by making the back inclined surface S3 of the installation base 124 extend toward the back B of the vehicle 200 and toward the inner side of the vehicle 200 in the vehicle width direction L-R, the air flow may be guided more effectively, and the increase of air resistance may be suppressed.

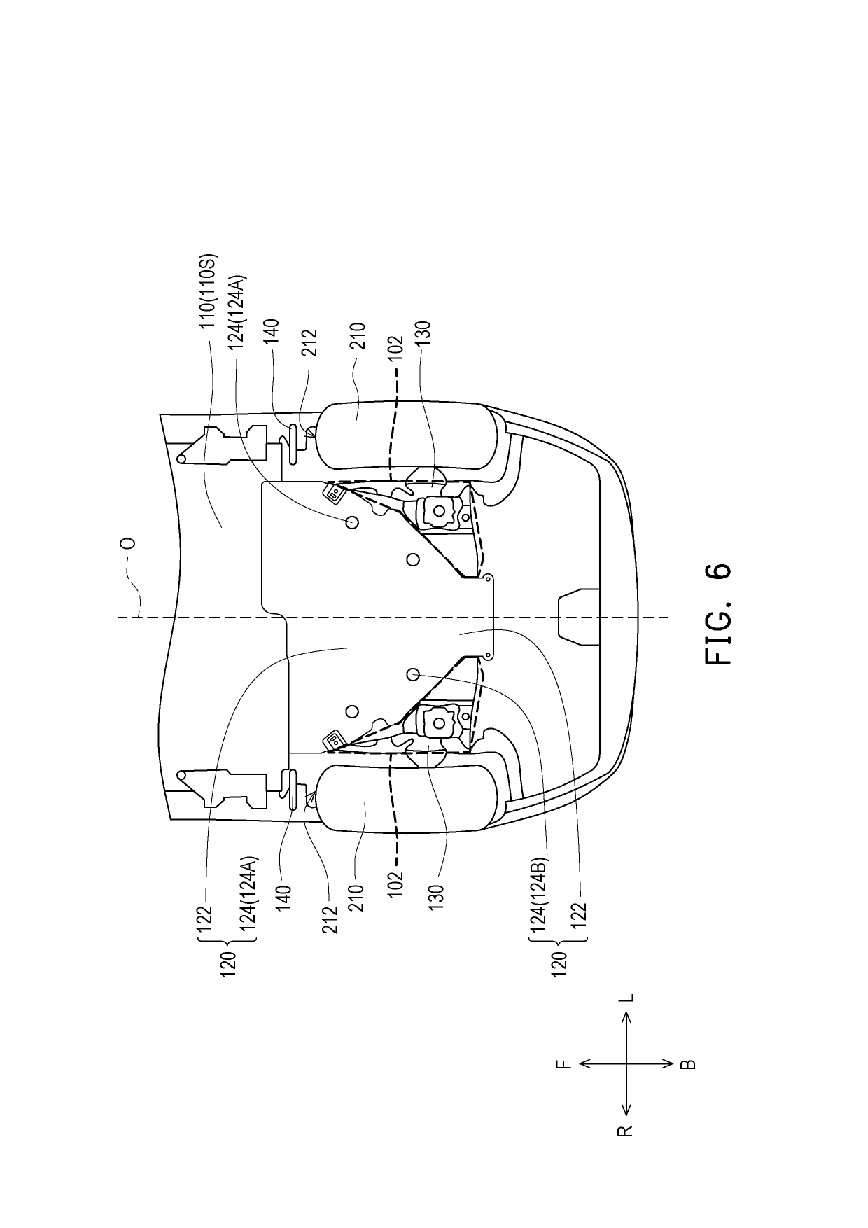

FIG. 6 is a schematic view of an uncovered area of a bottom structure of vehicle according to an embodiment of the disclosure. With reference to FIG. 6, on the inner side of the tire 210 in the vehicle width direction L-R, an uncovered area 102 that is not covered by the chassis 120 is formed. At least one installation base 124 is disposed on the inner side of the uncovered area 102 in the vehicle width direction L-R.

The air flow in the uncovered area 102 that is not covered by the chassis 120 is easily disturbed, making the flow velocity of the air in the uncovered area 102 slower than the flow velocity of the air in the center O of the vehicle body 110 where the chassis 120 is located. As the flow velocity of the air becomes slower, the air may flow toward a direction of the center O of the vehicle body 110 where the flow velocity is faster. Therefore, by disposing the installation base 124 on the inner side of the uncovered area 102 in the vehicle width direction L-R, and the back inclined surface S3 of the installation base 124 extending toward the back B of the vehicle 200 and toward the inner side of the vehicle 200 in the vehicle width direction L-R (with reference to FIG. 4), the increase of air resistance may be effectively suppressed.

With reference to FIG. 6, the bottom structure 100 of the vehicle 200 may further include a suspension component 130 disposed in the uncovered area 102. Even at portions where the air flow is easily disturbed by the suspension component 130, by the back inclined surface S3 of the installation base 124 extending toward the back B of the vehicle 200 and toward the inner side of the vehicle 200 in the vehicle width direction L-R (with reference to FIG. 4), the increase of air resistance may be effectively suppressed.

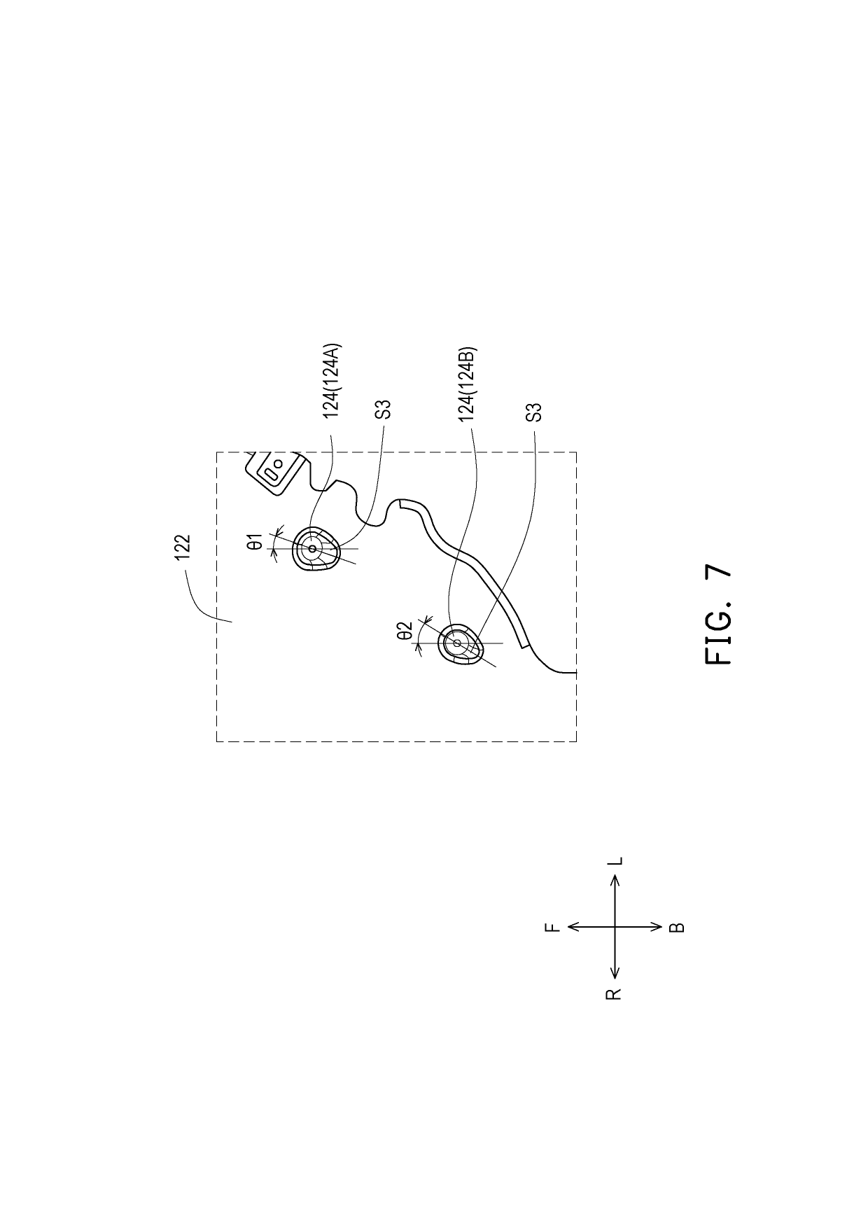

FIG. 7 is a schematic view of a first installation base and a second installation base of a bottom structure of vehicle according to an embodiment of the disclosure. With reference to FIG. 6 and FIG. 7, the installation base 124 may include a first installation base 124A disposed at the position closer to the back B of the vehicle 200 than the front part 212 of the tire 210, and disposed at the position on the inner side of the vehicle body 110 and a second installation base 124B disposed at the position closer to the back B of the vehicle 200 than the first installation base 124A, and disposed on the inner side of the uncovered area 102 in the vehicle width direction L-R. Relative to the back inclined surface S3 of the first installation base 124A, the back inclined surface S3 of the second installation base 124B extends by tilting toward the inner side in the vehicle width direction L-R.

With reference to FIG. 7, an extension direction of the back inclined surface S3 of the first installation base 124A has a tilt angle θ1 relative to the vehicle 200 in a front-back direction F-B. The extension direction of the back inclined surface S3 of the second installation base 124B has a tilt angle θ2 relative to the vehicle 200 in the front-back direction F-B. It may be noted that the tilt angle θ2 is greater than the tilt angle θ1, which indicates that the back inclined surface S3 of the second installation base 124B tilts toward the inner side of the vehicle body 110 to a greater extent than the back inclined surface S3 of the first installation base 124A.

The air flowing under the vehicle body 110 may impact the front part 212 of the tire 210, deflect toward the inner side of the vehicle body 110, and flow toward back of the inner side of the vehicle body 110. The air flowing toward the back of the inner side of the vehicle body 110 may be decelerated by the uncovered area 102 formed on the inner side of the tire 210, further deflect toward the inner side of the vehicle body 110, and flow toward the back of the inner side of the vehicle body 110. Accordingly, by making the back inclined surface S3 of the second installation base 124B tilt toward the inner side of the vehicle body 110 to a greater extent than the back inclined surface S3 of the first installation base 124A, shapes of the installation bases 124, 124A, 124B that follow the air flow may be formed, and the increase of air resistance may be suppressed more effectively.

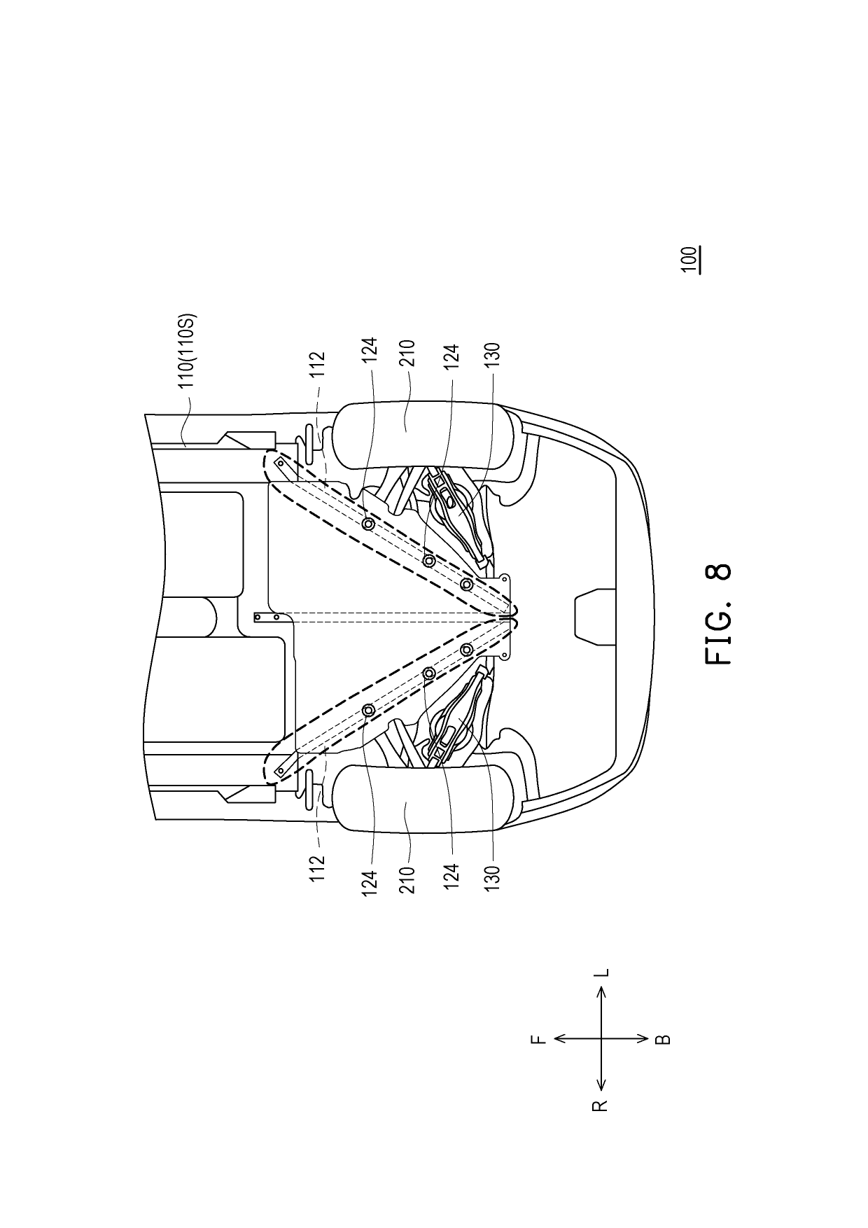

FIG. 8 is a schematic view of a frame component and a suspension component of a bottom structure of vehicle according to an embodiment of the disclosure. With reference to FIG. 8, the vehicle body 110 may include a frame component 112. The frame component 112 extends from front F of the tire 210 toward the back B of the vehicle 200 and toward the inner side in the vehicle width direction L-R. The installation base 124 is disposed along the frame component 112.

Since the frame component 112 extends from the front F of the tire 210 toward the back B of the vehicle 200 and toward the inner side in the vehicle width direction L-R, the installation base 124 may be easily disposed along a path of the air flow on the lower surface 110S of the vehicle body 100.

With reference to FIG. 8, the bottom structure 100 of the vehicle 200 may further include a suspension component 130 disposed on the inner side of the tire 210 in the vehicle width direction L-R. The frame component 112 is disposed on the inner side in the vehicle width direction L-R relative to the suspension component 130.

Since the frame component 112 is disposed on the inner side in the vehicle width direction L-R relative to the suspension component 130, the installation base 124 may be easily disposed along the path of the air flow on the lower surface 110S of the vehicle body 100.

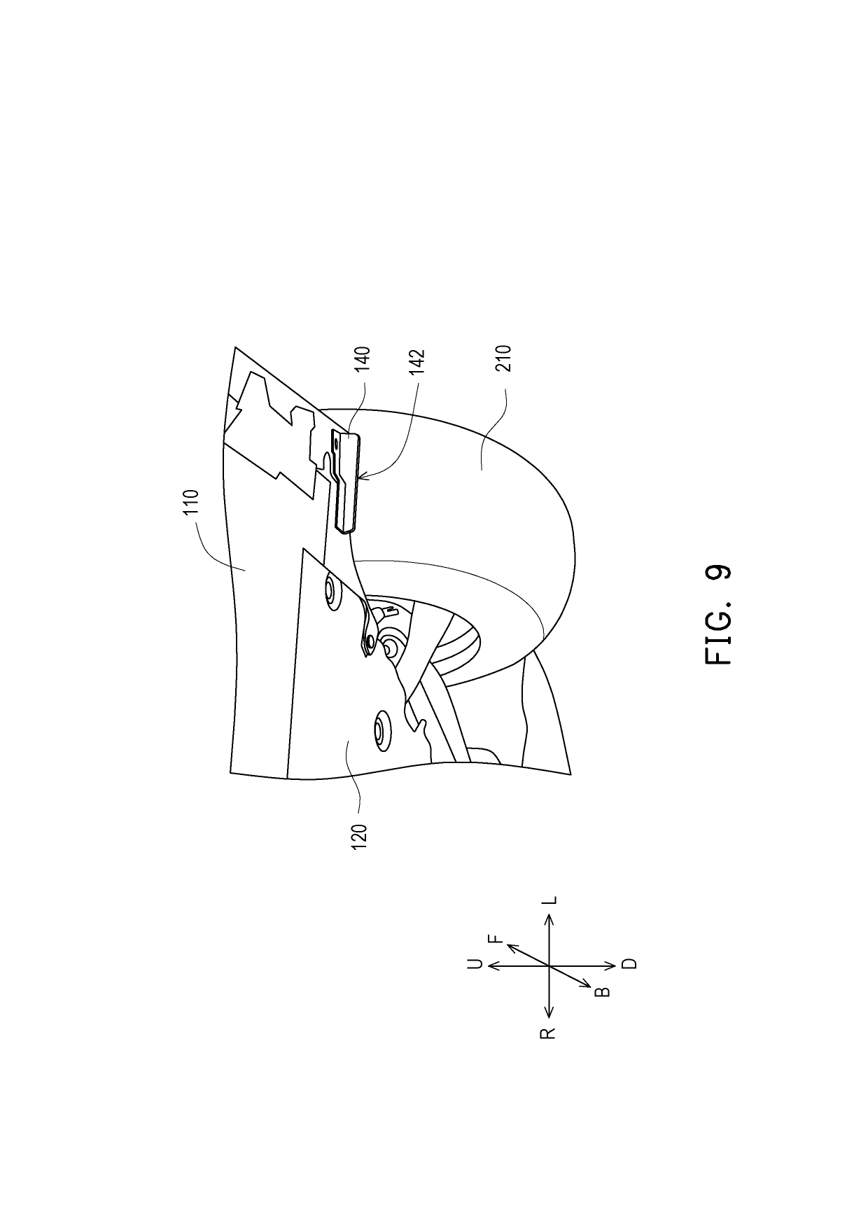

FIG. 9 is a schematic view of a strip plate of a bottom structure of vehicle according to an embodiment of the disclosure. With reference to FIG. 9, the bottom structure 100 of the vehicle 200 may further include a strip plate 140 disposed in front F of the tire 210. The strip plate 140 extends from the vehicle body 110 toward down D of the vehicle 200. A bottom part 142 of the strip plate 140 is located at down of the chassis 120.

Even when the flow velocity of the air of the side of the vehicle body 110 becomes slower than the flow velocity of the air in the center O of the vehicle body 110 due to the strip plate 140, the increase of air resistance may be effectively suppressed.

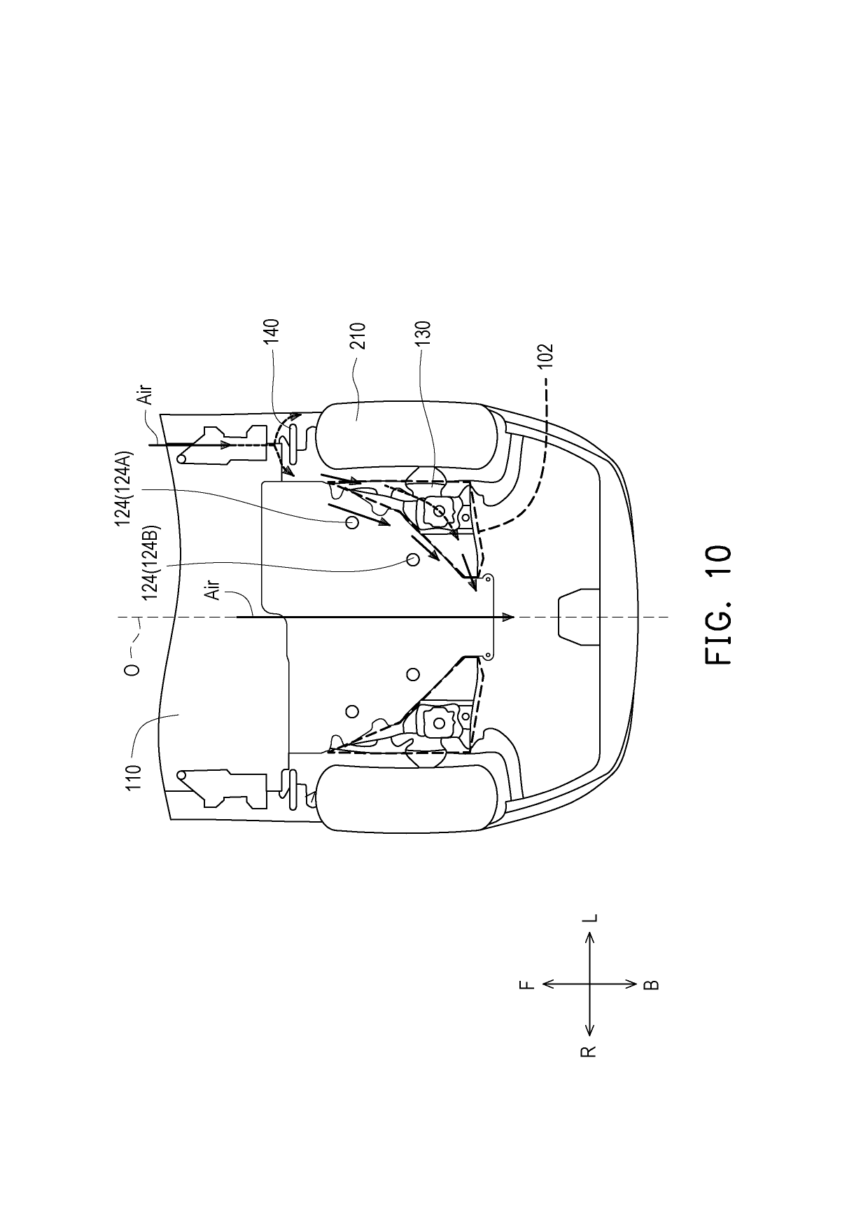

FIG. 10 is a schematic view of air flow of a bottom structure of vehicle according to an embodiment of the disclosure. With reference to FIG. 10, there is no obstruction at the position of the center O of the vehicle body 110, and therefore, the flow velocity of the air at the position of the center O of the vehicle body 110 is fast.

The air blocked by the strip plate 140 may be diverted and decelerated, flowing toward the inner side and outer side of the tire 210. The decelerated air flowing toward the inner side of the tire 210 may be guided into a fast flow velocity of the air in the center O of the vehicle body 110, and flow toward the back B of the vehicle body 110.

The suspension component 130 is disposed in the uncovered area 102. There is no chassis at down of the suspension component 130, and therefore, the flow velocity of the air entering the uncovered area 102 may become slow. A slow flow velocity of the air may also be guided into the fast flow velocity of the air in the center O of the vehicle body 110, and flow toward the back B of the vehicle body 110.

As shown in FIG. 10, the air may flow toward the back B of the vehicle body 110 along a disposing direction of the installation base 124. With reference to FIG. 5 simultaneously, the back inclined surface S3 of the installation base 124 is formed with a gentle tilt to prevent the air from entering the installation base 124 and suppressing generation of the turbulent flow. With reference to FIG. 7 simultaneously, the back inclined surface S3 of the second installation base 124B tilts toward the inner side of the vehicle body 110 to a greater extent than the back inclined surface S3 of the first installation base 124A. Therefore, the shape of the installation base 124 may follow the air flow to suppress air resistance effectively.

In summary, the bottom structure of vehicle of the disclosure has at least following technical effects.

In the embodiments of the bottom structure of vehicle of the disclosure, the air at down of the chassis flows rapidly in the center of the flat vehicle body. The air of the side of the chassis is disturbed by the tire, the strip plate, and the suspension component to slow down the velocity, and is guided to the center of the vehicle body with a faster flow the velocity. According to the position where the installation base is disposed, the installation base is disposed by tilting toward the center of the vehicle body. In this way, aerodynamic performance of the bottom structure of vehicle may be improved more effectively, and air resistance may be effectively suppressed, which contributes to efficiency of energy.

Finally, it should be noted that the above embodiments are only used to illustrate, but not to limit, the technical solutions of the disclosure. Although disclosure has been described in detail with reference to above embodiments, persons skilled in the art should understand that the technical solutions described in the above embodiments may still be modified or some or all of the technical features thereof may be equivalently replaced. However, the modifications or replacements do not cause the essence of the corresponding technical solutions to deviate from the scope of the technical solutions of the embodiments of the disclosure.

What is claimed is:

1. A bottom structure of a vehicle, disposed in the vehicle, the vehicle having tires, and the bottom structure of the vehicle comprising:
a vehicle body, with the tires disposed on a left side and a right side of the vehicle body; and
a chassis, covering a lower surface of the vehicle body between the tires on the left side and the right side from down of the vehicle,
wherein,
the chassis comprises:
a bottom plate surface, covering the lower surface of the vehicle body; and
an installation base, recessing from the bottom plate surface toward an inner side of a cabin of the vehicle,
the installation base is disposed at a position closer to the tire than a center of the vehicle body, and the installation base is disposed at a position closer to a back of the vehicle than a front part of the tire,
the installation base comprises:
an installation surface, configured to install the chassis to the vehicle body;
a front inclined surface, connected to the bottom plate surface and a front part of the installation surface; and
a back inclined surface, connected to a back part of the installation surface and the bottom plate surface, and
the back inclined surface is configured to have a gentler tilt than the front inclined surface, and extends from the installation surface toward the back of the vehicle and toward the inner side of the vehicle in a vehicle width direction.

2. The bottom structure of the vehicle according to claim 1, wherein
an uncovered area not covered by the chassis is formed on an inner side of the tire in the vehicle width direction, and
at least one of the installation base is disposed on an inner side of the uncovered area in the vehicle width direction.

3. The bottom structure of the vehicle according to claim 2, further comprising:
a suspension component, disposed in the uncovered area.

4. The bottom structure of the vehicle according to claim 2, wherein
the installation base comprises:
a first installation base, disposed at a position more toward the back of the vehicle than the front part of the tire, and disposed at a position on an inner side of the vehicle body; and
a second installation base, disposed at a position more toward the back of the vehicle than the first installation base, and disposed on an inner side of the uncovered area in the vehicle width direction; and
relative to a back inclined surface of the first installation base, a back inclined surface of the second installation base extends by tilting toward the inner side in the vehicle width direction.

5. The bottom structure of the vehicle according to claim 1, wherein
the vehicle body comprises a frame component,
the frame component extends from the front of the tire toward the back of the vehicle and toward the inner side in the vehicle width direction, and
the installation base is disposed along the frame component.

6. The bottom structure of the vehicle according to claim 5, further comprising:
a suspension component, disposed on the inner side of the tire in the vehicle width direction,
the frame component being disposed on the inner side in the vehicle width direction relative to the suspension component.

7. The bottom structure of vehicle according to claim 1, further comprising:
a strip plate, disposed in front of the tire,
the strip plate extending from the vehicle body toward down of the vehicle, and
a lower part of the strip plate being located at down of the chassis.

8. The bottom structure of the vehicle according to claim 2, further comprising:
a strip plate, disposed in front of the tire,
the strip plate extending from the vehicle body toward down of the vehicle, and
a lower part of the strip plate being located at down of the chassis.

9. The bottom structure of the vehicle according to claim 3, further comprising:
a strip plate, disposed in front of the tire,
the strip plate extending from the vehicle body toward down of the vehicle, and
a lower part of the strip plate being located at down of the chassis.

10. The bottom structure of the vehicle according to claim 4, further comprising:
a strip plate, disposed in front of the tire,
the strip plate extending from the vehicle body toward down of the vehicle, and
a lower part of the strip plate being located at down of the chassis.

11. The bottom structure of the vehicle according to claim 5, further comprising:
a strip plate, disposed in front of the tire,
the strip plate extending from the vehicle body toward down of the vehicle, and
a lower part of the strip plate being located at down of the chassis.

12. The bottom structure of the vehicle according to claim 6, further comprising:
a strip plate, disposed in front of the tire,
the strip plate extending from the vehicle body toward down of the vehicle, and
a lower part of the strip plate being located at down of the chassis.
